(19) United States
(12) Patent Application Publication
(10) Pub. No.: US 2017/0209940 A1
(43) Pub. Date: Jul. 27, 2017

(54) Lathe Chuck for Aluminum Alloy Hubs

(71) Applicant: CITIC Dicastal CO., LTD, Qinhuangdao (CN)

(72) Inventor: Jiandong Guo, Qinhuangdao (CN)

(73) Assignee: CITIC Dicastal CO., LTD, Qinhuangdao (CN)

(21) Appl. No.: 15/412,248

(22) Filed: Jan. 23, 2017

(30) Foreign Application Priority Data
Jan. 21, 2016 (CN) 201610039482.0

(51) Int. Cl. B23B 31/30

(52) U.S. Cl. CPC B23B 31/302; B23B 2215/08; B23B 2222/04; B23B 2270/025

(57) ABSTRACT

A lathe chuck for aluminum alloy hubs, including a base plate, a base, a slide plate, positioning posts, etc. The base plate is connected together with the base by screws, forming a body of the lathe chuck for hubs; a tapered mounting hole is provided under the base plate so as to fit with a machine tool; the upper and lower ends of the positioning posts are mounted on the base plate and the base by screws respectively, which can increase mounting strength of the base plate and the base; the slide plate is in sliding fit with the positioning posts by copper sleeves, and may slide upwards and downwards along the positioning posts; the large pull rod is fixed on the slide plate by screws and may drive the slide plate to move upwards and downwards.

### TECHNICAL FIELD

The invention relates to a lathe chuck, in particular to a lathe chuck for aluminum alloy hubs.

### BACKGROUND ART

An aluminum alloy hub is manufactured according to processes such as casting, machining and coating. During the machining process of the aluminum alloy hub, the hub blank needs to be placed on a specialized lathe fixture for positioning and clamping so as to perform lathe work. Since the demands of customers are diverse, the diameter of the hub blank varies. Currently, hub blanks of different sizes can only be made by changing lathe chucks of different diameters and specifications. This not only wastes time, but also increases labor intensity for workers and decreases throughput.

### SUMMARY OF THE INVENTION

The objective of the invention is to provide a lathe chuck for aluminum alloy hubs. For achieving the aforementioned objective, a technical scheme of the invention is a lathe chuck for aluminum alloy hubs, mainly comprising a base plate, a base, a slide plate, positioning posts, a large pull rod, a small pull rod, a hydraulic power collet, a lateral pull rod, positioning blocks, a slide carriage, press claws, press claw shafts, etc. The base plate is connected together with the base by screws, forming a body of the lathe chuck for hubs; a tapered mounting hole is provided under the base plate so as to fit with a machine tool; the upper and lower ends of the positioning posts are mounted on the base plate and the base by screws respectively, which can increase mounting strength of the base plate and base; the slide plate is in sliding fit with the positioning posts by copper sleeves, and may slide upwards and downwards along the positioning posts; the large pull rod is fixed on the slide plate by screws and may drive the slide plate to move upwards and downwards; the small pull rod is coupled with the hydraulic power collet, which is fixed on the base plate by a gland and may drive the slide carriage to move leftward and rightward by the lateral pull rod under the driving of the small pull rod; the positioning blocks are mounted on the slide carriage; the press claws are coupled together with the press claw shafts by screws; the press claw shafts may slide upwards and downwards and rotate in the slide carriage; the lower ends of the press claw shafts are mounted on the slide plate.

Upper planes and inclined sides of the positioning blocks in contact with the hub blank provide end face positioning and radial positioning for the blank respectively so as to ensure correct positioning of the blank.

The positioning blocks, the press claws and the press claw shafts move along when the hydraulic power collet drives the slide plate to move leftward and rightward by the lateral pull rod, so that the chuck may be adapted to hub blanks of different sizes; three sets of positioning blocks, press claw shafts and press claws are provided and are uniformly distributed in a circumferential direction.

When the slide plate moves downwards, it pulls the press claw shafts to move down; as spiral grooves are provided at fitting portions of the press claw shafts and the slide carriage, the press claw shafts and press claws rotate by 90 degrees, thus finishing rotating and pressing operations. The slide plate is provided with elongated slots at its outer side, in which the press claw shafts may slide from side to side.

The large pull rod and the small pull rod are respectively connected with a double-rod cylinder at the rear of a lathe spindle by a hollow shaft and a solid shaft and respectively operate under the driving of the cylinder.

Prior to operation, the large pull rod and the small pull rod are both at the uppermost end, where the large pull rod allows the press claw shafts and the press claws opened by the slide plate, and the small pull rod allows the slide carriage, the press claw shafts, the press claws and the positioning blocks at the outermost position, i.e., the largest diameter position, by the hydraulic power collet and the lateral rod.

During operation, an aluminum alloy hub blank is placed at first, an outer end face portion of the blank is naturally placed on the positioning blocks so as to finish end face positioning; an outer peripheral portion of the blank is placed at the inner sides of the inclined sides of the positioning blocks; then the small pull rod drives the hydraulic power collet and the lateral pull rod to drive the slide carriage, the positioning blocks, the press claw shafts and the press claws to move towards the center of circle until they abut against the outer peripheral portion of the blank, and thus the end face positioning and radial positioning are finished.

Then the large pull rod drives the slide plate to move downwards, the slide plate pulls the press claw shafts to move downwards so as to finish the actions of rotating and pressing the blank, thus the end face positioning, radial positioning and pressing operations for the aluminum alloy hub blank are finished.

As the hydraulic power collet has a large stroke, the positioning blocks, the slide carriage, the press claw shafts and the press claws can move in a large range, so that compatibility with aluminum alloy hub blanks of different sizes can be provided.

The invention is wide in compatible range, precise and reliable in positioning and stable in operation, and thus it is suitable for use on machining lathes for aluminum alloy hubs.

### BRIEF DESCRIPTION OF THE DRAWINGS

The invention will be further explained below with reference to the drawings and embodiments.

FIG. 1 is a front view of a lathe chuck for aluminum alloy hubs of the invention.

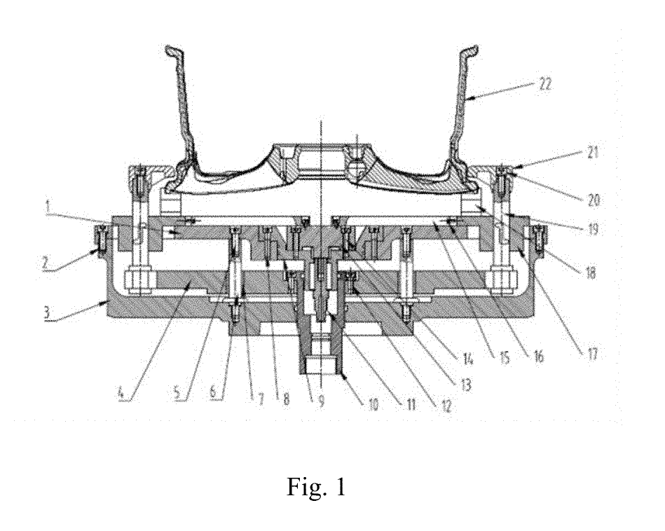

FIG. 2 is a front view of a lathe chuck for aluminum alloy hubs of the invention clamping a hub blank of other size.

FIG. 3 is a front view of a lathe chuck for aluminum alloy hubs of the invention connected with a cylinder of a machine tool.

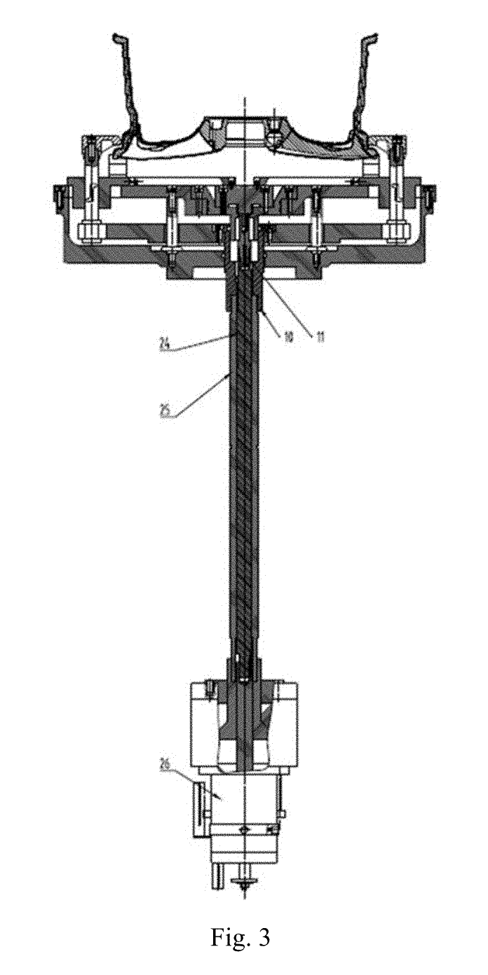

### DETAILED DESCRIPTION OF THE INVENTION

Details and operations of specific devices provided according to the invention will be explained in detail below with reference to the drawings.

A lathe chuck for aluminum alloy hubs comprises a base plate 1, a base 3, a slide plate 4, positioning posts 6, a large pull rod 10, a small pull rod 11, a hydraulic power collet 13, a lateral pull rod 15, positioning blocks 18, a slide carriage 17, press claws 21, press claw shafts 19, etc. The base plate 1 is connected together with the base 3 by screws 2, forming a body of the lathe chuck for hubs; a tapered mounting hole is provided under the base plate 1 so as to fit with a machine tool; the upper and lower ends of the positioning posts 6 are mounted on the base plate 1 and the base 3 by screws 5 respectively, which can increase mounting strength of the base plate 1 and the base 3; the slide plate 4 is in sliding fit with the positioning posts 6 by copper sleeves 7, and may slide upwards and downwards along the positioning posts 6; the large pull rod 10 is fixed on the slide plate 4 by screws 12 and may drive the slide plate 4 to move upwards and downwards; the small pull rod 11 is coupled with the hydraulic power collet 13, which is fixed on the base plate 1 by a gland 9 and may drive the slide carriage 17 to move leftward and rightward by the lateral pull rod 15 and screws 16 under the driving of the small pull rod 11; the positioning blocks 18 are mounted on the slide carriage 17; the press claws 21 are coupled together with the press claw shafts 19 by screws 20; the press claw shafts 19 may slide upwards and downwards and rotate in the slide carriage 17; the lower ends of the press claw shafts 19 are mounted on the slide plate 4.

Upper planes and inclined sides of the positioning blocks 18 in contact with the hub blank 22 provide end face positioning and radial positioning for the blank 22 respectively so as to ensure correct positioning of the blank.

The positioning blocks 18, the press claws 21 and the press claw shafts 19 move along when the hydraulic power collet 13 drives the slide carriage 17 to move leftward and rightward by the lateral pull rod 15, so that the chuck may be adapted to hub blanks of different sizes; three sets of positioning blocks 18, press claw shafts 19 and press claws 21 are provided and are uniformly distributed in a circumferential direction.

When the slide plate 4 moves downwards, it pulls the press claw shafts 19 to move down; as spiral grooves are provided at fitting portions of the press claw shafts 19 and the slide carriage 17, the press claw shafts 19 and press claws 21 rotate by 90 degrees, thus finishing rotating and pressing operations.

The slide plate 4 is provided with elongated slots at its outer side, in which the press claw shafts 19 may slide from side to side.

The large pull rod 10 and the small pull rod 11 are respectively connected with a double-rod cylinder 26 at the rear of a lathe spindle by a hollow shaft 25 and a solid shaft 24 and respectively operate under the driving of the cylinder 26.

Prior to operation, the large pull rod 10 and the small pull rod 11 are both at the uppermost end, where the large pull rod 10 allows the press claw shafts 19 and the press claws 21 opened by the slide plate 4, and the small pull rod 11 allows the slide carriage 17, the press claw shafts 19, the press claws 21 and the positioning blocks 18 at the outermost position, i.e., the largest diameter position, by the hydraulic power collet 13 and the lateral pull rod 15.

During operation, an aluminum alloy hub blank 22 is placed at first, an outer end face portion of the blank 22 is naturally placed on the positioning blocks 18 so as to finish end face positioning; an outer peripheral portion of the blank 22 is placed at the inner sides of the inclined sides of the positioning blocks 18; then the small pull rod 11 drives the hydraulic power collet 13 and the lateral pull rod 15 to drive the slide carriage 17, the positioning blocks 18, the press claw shafts 19 and the press claws 21 to move towards the center of circle until they abut against the outer peripheral portion of the blank 22, thus the end face positioning and radial positioning are finished.

Then the large pull rod 10 drives the slide plate 4 to move downwards, the slide plate 4 pulls the press claw shafts 19 to move downwards so as to finish the actions of rotating and pressing the blank, thus the end face positioning, radial positioning and pressing operations for the aluminum alloy hub blank are finished.

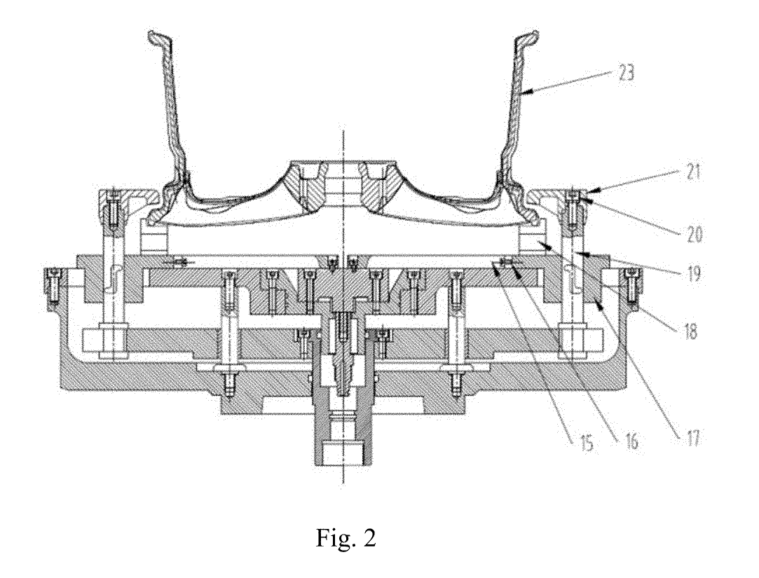

As hydraulic power collet 13 has a large stroke, the positioning blocks 18, the slide carriage 17, the press claw shafts 19 and the press claws 21 can move in a large range, so that compatibility with aluminum alloy hub blanks of different sizes can be provided. FIG. 2 is the state when a small-sized hub blank 23 is clamped.

1. A lathe chuck for aluminum alloy hubs, comprising:
a base plate, a base, a slide plate, positioning posts, a large pull rod, a small pull rod, a hydraulic power collet, a lateral pull rod, positioning blocks, a slide carriage, press claws and press claw shafts, wherein the base plate is connected together with the base by screws, forming a body of the lathe chuck for hubs; a tapered mounting hole is provided under the base plate so as to fit with a machine tool; upper and lower ends of the positioning posts are mounted on the base plate and the base by screws respectively; the slide plate is in a sliding fit with the positioning posts by copper sleeves to slide upwards and downwards along the positioning posts; the large pull rod is fixed on the slide plate by screws to drive the slide plate to move upwards and downwards; the small pull rod is coupled with the hydraulic power collet, which is fixed on the base plate by a gland to drive the slide carriage to move leftward and rightward by the lateral pull rod and screws under a driving of the small pull rod; the positioning blocks are mounted on the slide carriage; the press claws are coupled together with the press claw shafts by screws; the press claw shafts slide upwards and downwards and rotate in the slide carriage; and lower ends of the press claw shafts are mounted on the slide plate.

2. The lathe chuck for aluminum alloy hubs according to claim 1, wherein upper planes and inclined sides of the positioning blocks in contact with a hub blank provide end face positioning and radial positioning for the blank respectively.

3. The lathe chuck for aluminum alloy hubs according to claim 1, wherein the positioning blocks, the press claws and the press claw shafts move along when the hydraulic power collet drives the slide carriage to move leftward and rightward by the lateral pull rod, so that the chuck is adapted to hub blanks of different sizes; three sets of positioning blocks, press claw shafts and press claws are provided and are uniformly distributed in a circumferential direction.
